(19) United States
(12) Patent Application Publication
(10) Pub. No.: US 2010/0108661 A1
(43) Pub. Date: May 6, 2010

(54) MULTI-LAYER HEATING ASSEMBLY AND METHOD

(75) Inventors: John H. Vontell, Manchester, CT (US); George Alan Salisbury, East Hampton, CT (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: UNITED TECHNOLOGIES CORPORATION, Hartford, CT (US)

(21) Appl. No.: 12/262,501

(22) Filed: Oct. 31, 2008

(51) Int. Cl. B23K 13/08; B60L 1/02

(52) U.S. Cl. 219/477; 219/205

(57) ABSTRACT

A multi-layer heating assembly, configured to be embedded inside or mounted on a component and to provide ice protection for the component, includes a first heating element, a second heating element, and a dielectric support having opposed first and second surfaces. The first heating element is located on the first surface and the second heating element is located on the second surface. The multi-layer heating assembly is configured to provide failure immunity or variable watt density.

### STATEMENT OF GOVERNMENT INTEREST

The U.S. Government has a paid-up license in this invention and the right in limited circumstances to require the patent owner to license others on reasonable terms as provided for by the terms of Contract No. N00019-02-C-3003 awarded by the United States Navy.

### BACKGROUND

The present invention relates to a multi-layer heating assembly. More particularly, the present invention relates to a multi-layer heating assembly with failure immunity and variable watt density.

It is desirable to minimize or prevent the formation of ice on certain components of a gas turbine engine in order to avoid problems attributable to ice accumulation. There are many existing methods of removing or preventing the formation of ice on gas turbine engine components and airframe components. Among these methods is the incorporation (or embedding) of an electrothermal heating element into a gas turbine engine or airframe component that is susceptible to ice formation. The heating element may also be applied to a surface of the component. The heating element heats the susceptible areas of the component in order to prevent ice from forming.

The heating element may be a metallic heating element which typically converts electrical energy into heat energy. The metallic heating element is typically a part of a heater assembly that also includes at least one layer that electrically insulates the heating element. For example, the heater assembly may be formed of a metallic heating element embedded into a fiber-reinforced composite structure.

Typically, these types of heating elements have limitations. First, due to design space limitations, these heating elements generally do not offer failure immunity afforded by a redundant heating element. If a heating element fails or malfunctions, additional heating elements are not available to provide ice protection in that area. Second, the watt density of the heating element is determined at the time the heating element is constructed. Watt density is determined by the width and thickness of the heating element and the spacing of the heating element pattern. Once provided, the watt density of the heating element is fixed and cannot be changed. Increased watt density in a particular area of the gas turbine engine cannot be provided during flight where conditions might arise that require it.

### SUMMARY

An exemplary embodiment of the present invention is an apparatus for ice protection. The apparatus includes a first heating element, a second heating element, and a dielectric support. The dielectric support has a first surface and a second surface opposite the first surface. The first heating element is located on the first surface and the second heating element is located on the second surface.

A further exemplary embodiment of the present invention is an apparatus having first, second, third, and fourth conductive layers. The apparatus also includes a plurality of dielectric supports spaced between the first and second conductive layers, the second and third conductive layers and the third and fourth conductive layers. At least one of the conductive layers is configured to provide ice protection.

Another exemplary embodiment of the present invention is a method of preventing ice accumulation on a component. The method includes mounting a multi-layer heating assembly to the component where the multi-layer heating assembly includes a first heating element, a second heating element, and a dielectric support. The method also includes providing electrical energy to at least one of the first and second heating elements to heat the component.

### BRIEF DESCRIPTION OF THE DRAWINGS

FIG. 1 is a schematic top view of a multi-layer heating assembly having thin metal foil heating elements and a dielectric support.

FIG. 2 is a schematic end view of a multi-layer heating assembly having two heating elements and a dielectric support.

FIG. 3 is a schematic end view of a multi-layer heating assembly having multiple heating elements and multiple dielectric supports.

FIG. 4 is a schematic end view of a multi-layer heating assembly having multiple heating elements, dielectric supports and vias.

FIG. 5 is a schematic end view of a multi-layer heating assembly having multiple conductive layers, heating elements, dielectric supports and vias.

FIG. 6 is a schematic end view of a multi-layer heating assembly having multiple conductive layers, a sensor, a heating element, multiple dielectric supports and vias.

### DETAILED DESCRIPTION

The present invention relates to a multi-layer heating assembly configured to be embedded inside or mounted onto an engine or aircraft component. The multi-layer heating assembly includes at least one layer of a thin metal foil or thermal sprayed metal configured as a metallic heating element. The multi-layer heating assembly may be a composite structure formed from fabric layers or polymer films that surround the metal foil layers. The fabric layers or polymer films commonly include at least one non-conductive layer that electrically isolates the metal foil layers.

The heating assembly may be embedded inside or surface-mounted on any component that is susceptible to ice formation. For example, the component may be an aircraft component or a gas turbine engine component such as, but not limited to, a vane, an airfoil, a front bearing housing of the engine, a structural strut that supports the front bearing, a fan inlet shroud fairing or a duct. The component may be formed of materials such as, but not limited to, metal, polymer matrix composites (PMC) (which may be reinforced with polymeric, glass, carbon or ceramic fibers), metal matrix composites, metal, ceramic matrix composites (CMC), and carbon/carbon composites.

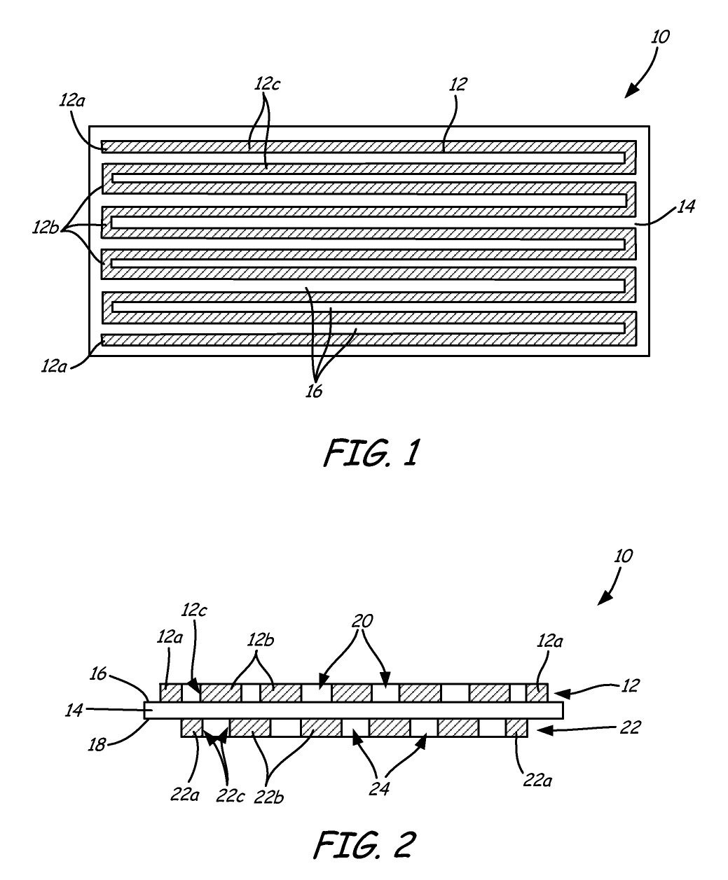

FIG. 1 is a schematic top view of a multi-layer heating assembly 10 having a thin metal foil heating element 12 and a dielectric support 14. Because it is a top view, FIG. 1 shows only one heating element 12 (on top of dielectric support 14) on the multi-layer heating assembly 10. Additional heating elements may be located underneath dielectric support 14. Heating element 12 is a thin metal foil and is designed as a metallic heating element, which converts electrical energy into thermal heat, as is known in the art. Heating element 12 may be titanium as described in U.S. patent application Ser. No. 11/591,327, the contents of which are incorporated herein by reference in their entirety. Other suitable materials for thin metal foil heating elements 12 include resistive heating elements such as stainless steel, copper and wire cloth heating elements. Multi-layer heating assembly 10 is embedded into a component or mounted on its surface.

As illustrated in FIG. 1, heating element 12 has a generally serpentine circuitous pattern. In this embodiment, heating element 12 is one continuous segment. In alternative embodiments, heating element 12 may have more complex geometry and may include multiple segments that are interconnected. The generally serpentine circuitous pattern of heating element 12 defines the heating path trace. Heating element 12 includes termini 12a, turns (or “racetrack” portions) 12b, and legs 12c, which connect turns 12b to termini 12a or to other turns 12b. Heating element 12 is electrically connected to an electrical power source using any suitable conductor, such as a wire or a flexible circuit at a terminus 12a (not shown). The electrical energy may be intermittently or continuously supplied to heating element 12, depending upon whether a deicing or anti-icing function is desired. Electrical energy follows the heating path trace of heating element 12 from one terminus 12a to the other along the generally serpentine circuitous pattern. As electrical energy travels through heating element 12, its resistance causes a portion of that electrical energy to be emitted as thermal energy from the heating path trace. Open areas 16 indicate spacing between adjacent legs 12c of the heating path trace and are regions (cold regions) that are not directly heated by heating element 12.

In the embodiment of FIG. 1, heating element 12 has a thickness of approximately 0.001 inches (0.0254 mm). A suitable range for the thickness of heating element 12 is approximately 0.0005 inches to 0.005 inches (0.0127 to 0.127 mm), while an exemplary range is approximately 0.001 inches to 0.003 inches (0.0254 to 0.0762 mm). A thin foil may be ideal due to limited space inside the component. Other factors which may limit the thickness of the foil include weight restrictions of the component and an overall efficiency of the foil as a heater.

The width of the paths of heating element 12 will vary depending on the amount of watt density needed for a particular multi-layer heating assembly 10. In the embodiment of FIG. 1, heating element 12 has a width of about 0.1 inches (2.54 mm). The widths of open areas 16 in between the paths of heating element 12 will also vary depending on the amount of watt density needed and the voltage applied across heating element 12. Open areas 16 have a minimum width of about 0.05 inches (1.27 mm) or greater.

Each metal foil heating element 12 is generally attached to one or more dielectric supports 14. Heating elements 12 may be attached to a dielectric support 14 by film adhesives. Film adhesives may be fiberglass scrim supported bismaleimide (BMI) film adhesives. Other materials that may be used in film adhesives include, but are not limited to, polyimide, polyester, phenolic, cyanate ester, epoxy, fluoropolymer, silicone, elastomers and phthalonitrile.

Dielectric supports 14 are made up of electrically non-conductive materials, such as polyimide film. Dielectric supports 14 may also be electrically non-conductive fabric polymer matrix composites (PMC) or other non-conductive polymer films. In the embodiment of FIG. 1, dielectric support 14 generally has a thickness of approximately 0.002 inches (0.0508 mm). A suitable range for the thickness of dielectric supports 14 is approximately 0.001 inches to 0.003 inches (0.0254 to 0.0762 mm), while an exemplary range is approximately 0.001 inches to 0.002 inches (0.0254 to 0.0508 mm).

Watt density is a result of both a trace watt density, which is the density along the trace of the resistive heating element circuit pattern, and a substrate watt density, which is the amount of coverage of the resistive circuit pattern across the dielectric support. In areas where the spacing between heating element trace paths are closer, the watt density is higher. Conversely, in areas where the heating element trace paths are farther apart, the watt density is lower. In areas where the heating element trace is thinner, the watt density is higher. Conversely, in areas where the heating element trace is thicker or wider, the watt density is lower. Heating elements in the prior art have used these principles to vary the watt density of heating assemblies. However, these heating elements are unable to provide a variable watt density once they have been fixed to the substrate. Once applied, the watt densities are not modifiable.

FIG. 2 is a schematic end view of a multi-layer heating assembly 10 having two heating elements and a dielectric support. Unlike the heating elements of the prior art described above, this embodiment is able to provide failure immunity and variable watt density. As illustrated in FIG. 2, dielectric support 14 includes a first surface 16 and a second surface 18. Second surface 18 is on the opposite side of dielectric support 14 as first surface 16. In this illustration, the first surface 16 is a top surface, while the second surface 18 is a bottom surface.

First heating element 12 is located on first surface 16. First heating element 12 is a thin metal foil heating element as described above in reference to FIG. 1. FIG. 2 illustrates a side view of the heating path trace. First heating element 12 includes termini 12a, turns 12b and legs 12c (not shown) as described above in reference to FIG. 1. Open areas 20 indicate spacing between legs of the heating path trace. Second heating element 22 is located on second surface 18. Second heating element 22 is also a thin metal foil heating element as described above. Second heating element 22 includes termini 22a, turns 22b and legs 22c (not shown). Open areas 24 indicate spacing between legs of the heating path trace.

The heating path traces of first heating element 12 and second heating element 22 may be arranged in an overlapping (mirror image) or offset configuration. The embodiment illustrated in FIG. 2 shows that the heating path trace of first heating element 12 and the heating path trace of second heating element 22 are stacked and offset with respect to each other. Thus, the heating path trace of first heating element 12 is generally located so that legs 12c are positioned above open areas 24 of second heating element 22 Likewise, the heating path trace of second heating element 22 is generally located so that legs 22c are positioned below open areas 20 of first heating element 12. This configuration allows thermal energy to be delivered with little or no overlap so that heat is distributed evenly and the number of cold zones (areas that do not receive heat) are eliminated or reduced.

This arrangement provides heating assembly 10 with the potential for failure immunity. In the event that first heating element 12 fails or malfunctions, second heating element 22 may still provide heat and function to protect the component it is embedded in from ice accumulation. If second heating element 22 fails or malfunctions, first heating element 12 may still provide heat. Thus, this arrangement provides for heating element redundancy (failure immunity) should one of the heating elements become inoperable.

This arrangement also provides multi-layer heating assembly 10 with the potential for increased watt density. Activation of first heating element 12 provides multi-layer heating assembly 10 with a first watt density. Further activation of the second heating element 22 provides additional wattage to the same general area of the substrate (dielectric support 14). When both heating elements 12, 22 are activated, additional watt density is provided to multi-layer heating assembly 10. Thus, first heating element 12 may be activated to provide a first watt density. If additional watt density is needed, to de-ice a component in certain conditions, for example, second heating element 22 may also be activated to provide the additional watt density.

First heating element 12 and second heating element 22 may be connected in various ways depending on the desired function of the multi-layer heating assembly 10. In one embodiment, first heating element 12 and second heating element 22 may be parallel circuits (each element is on a different circuit but both are controlled by a single controller). A parallel arrangement allows for watt density higher than that provided by a single heating element. In another embodiment, first heating element 12 and second heating element 22 may be connected in series. As in the parallel arrangement, the series circuits are controlled by a single controller. An electrically conductive through hole (plated through hole or via) extending through dielectric support 14 may provide the series connection. A series arrangement also allows for watt density higher than that provided by a single heating element.

In other embodiments, first heating element 12 and second heating element 22 are controlled independently. In an embodiment with redundant heating elements, first heating element 12 heats the component while second heating element 22 remains inactive. When first heating element 12 fails, second heating element 22 is activated and heats the component. In another embodiment, first heating element 12 and second heating element 22 are controlled by two independent controllers. Since the two heating elements are controlled independently, the watt density is controllable between a minimum value of the lowest watt density heating element and a maximum value of the combined watt density of both heating elements.

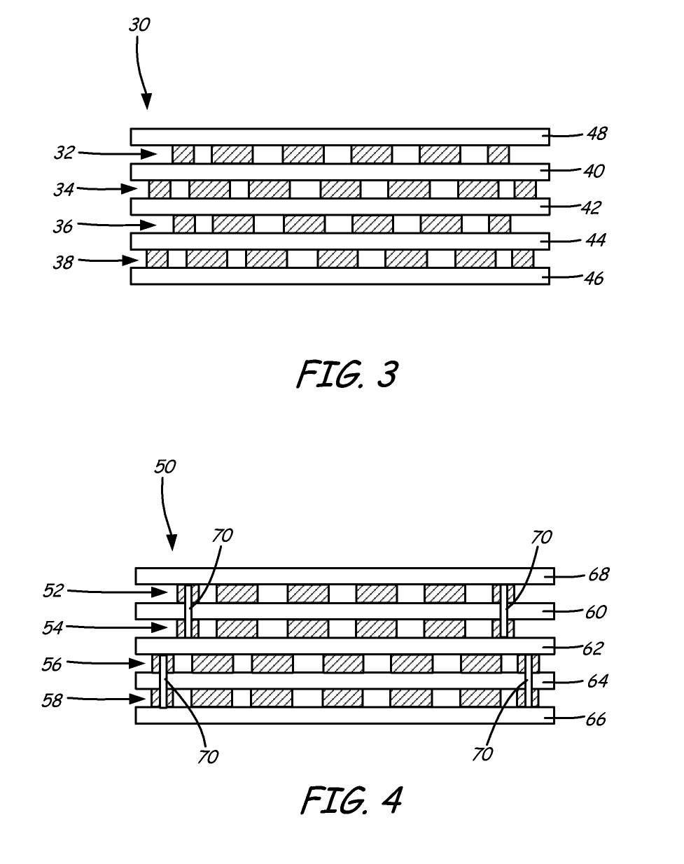

FIG. 3 is a schematic view of a multi-layer heating assembly 30 having multiple heating elements and multiple dielectric supports. Multi-layer heating assembly 30 includes heating elements 32, 34, 36 and 38 and dielectric supports 40, 42, 44 and 46. The heating elements and dielectric supports have the same properties as those described above. In this embodiment, dielectric support 40 is located between heating elements 32 and 34. Dielectric support 42 is located between heating elements 34 and 36. Dielectric support 44 is located between heating elements 36 and 38. Dielectric support 46 is located underneath heating element 38. Multi-layer heating assembly 30 may optionally include an electrically non-conductive cover layer 48 above heating element 32 to isolate the assembly from other structural components. Cover layer 48 may be made up of electrically non-conductive materials, such as polyimide. Cover layer 48 may also be electrically non-conductive fabric polymer matrix composites (PMC) or other non-conductive polymer films.

In the embodiment illustrated in FIG. 3, each heating element is stacked and offset with respect to adjacent heating elements. Thus, heating elements 32 and 34 are stacked and offset with respect to each other, heating elements 34 and 36 are stacked and offset with respect to each other and heating elements 36 and 38 are stacked and offset with respect to each other. As a result of the stacked and offset configuration, heating elements 32 and 36 overlap and heating elements 34 and 38 also overlap. The stacked and offset configuration allows the heating elements to evenly distribute heat throughout multi-layer heating assembly 30. Heating elements 32, 34, 36 and 38 may be connected in series or in parallel or may be controlled independently to provide failure immunity or variable watt density.

FIG. 4 is a schematic view of a multi-layer heating assembly 50 having multiple heating elements, dielectric supports and vias. Multi-layer heating assembly 50 includes heating elements 52, 54, 56 and 58 and dielectric supports 60, 62, 64 and 66. The heating elements and dielectric supports have the same properties as those described above. In this embodiment, dielectric support 60 is located between heating elements 52 and 54. Dielectric support 62 is located between heating elements 54 and 56. Dielectric support 64 is located between heating elements 56 and 58. Dielectric support 66 is located underneath heating element 58. Multi-layer heating assembly 50 may optionally include an electrically non-conductive cover layer 68 above heating element 52 to isolate the assembly from other structural components.

In the embodiment illustrated in FIG. 4, heating elements 52 and 54 overlap and heating elements 56 and 58 overlap. Heating elements 54 and 56 are stacked and offset with respect to each other. Thus, heating elements 52 and 54 form a first group, heating elements 56 and 58 form a second group, and the two groups are stacked and offset with respect to each other. The heating elements in each group are connected by vias 70. Heating elements 52 and 54 are connected by vias 70 and heating elements 56 and 58 are also connected by vias 70. FIG. 4 shows two via connections within each group, but more or fewer via connections may be present depending on whether the two heating elements are connected in series or parallel and the number of heating element segments present in a heating element layer.

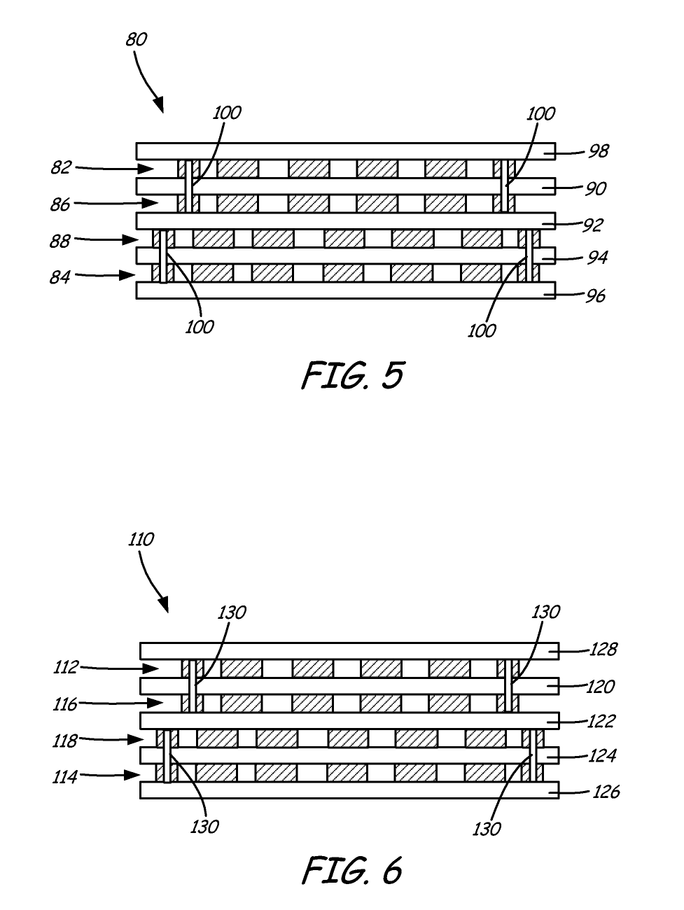

FIG. 5 is a schematic view of a multi-layer heating assembly 80 having multiple conductive layers, heating elements, dielectric supports and vias. Multi-layer heating assembly 80 includes conductor layers 82 and 84, heating elements 86 and 88, and dielectric supports 90, 92, 94 and 96. The heating elements and dielectric supports have the same properties as those described above. Conductor layers 82, 84 are configured to conduct electrical energy with minimal resistance. Conductor layers 82, 84 do not produce large amounts of thermal energy as electrical energy flows through them, but rather serves as conductive paths for the delivery of electrical energy to other structures within or near the component. Conductor layers 82, 84 are typically copper, but other conductive materials with low resistance may be suitable.

In this embodiment, dielectric support 90 is located between conductor layer 82 and heating element 86. Dielectric support 92 is located between heating elements 86 and 88. Dielectric support 94 is located between heating element 88 and conductor layer 84. Dielectric support 96 is located underneath conductor layer 84. Multi-layer heating assembly 80 may optionally include an electrically non-conductive cover layer 98 above conductor layer 82 to isolate the assembly from other structural components.

In the embodiment illustrated in FIG. 5, conductor layer 82 and heating element 86 overlap and heating element 88 and conductor layer 84 overlap. Heating elements 86 and 88 are stacked and offset with respect to each other. Thus, conductor layer 82 and heating element 86 form a first group, heating element 88 and conductor layer 84 form a second group, and the two groups are stacked and offset with respect to each other. The conductor layer and heating element in each group are connected by vias 100. Conductor layer 82 and heating element 86 are connected by vias 100 and heating element 88 and conductor layer 84 are also connected by vias 100. FIG. 5 shows two via connections within each group, but more or fewer via connections may be present depending on whether the conductor layers and heating elements are connected in series or parallel and the number of conductor or heating element segments present in a conductor or heating element layer.

FIG. 6 is a schematic view of a multi-layer heating assembly 110 having multiple conductive layers and dielectric supports, a sensor, a heating element and vias. Multi-layer heating assembly 110 includes conductor layers 112 and 114, sensor 116, heating element 118, and dielectric supports 120, 122, 124 and 126. The conductor layers, heating elements and dielectric supports have the same properties as those described above. Sensor 116 may be a temperature sensor. Sensor 116 may be a thermocouple, thermistor or resistance temperature detector (RTD). In the embodiment illustrated in FIG. 6, sensor 116 is a resistance temperature detector (RTD), as is known in the art. An RTD sensor 116 is generally platinum. Sensor 116 uses the resistance of an electric current passed through it to determine temperature. Sensor 116 may activate heating element 118 if the resistance indicates that the component temperature is too low.

In this embodiment, dielectric support 120 is located between conductor layer 112 and sensor 116. Dielectric support 122 is located between sensor 116 and heating element 118. Dielectric support 124 is located between heating element 118 and conductor layer 114. Dielectric support 126 is located underneath conductor layer 114. Multi-layer heating assembly 110 may optionally include an electrically non-conductive cover layer 128 above conductor layer 112 to isolate the assembly from other structural components.

In the embodiment illustrated in FIG. 6, conductor layer 112 and sensor 116 overlap and heating element 118 and conductor layer 114 overlap. Sensor 116 and heating element 118 are stacked and offset with respect to each other. Thus, conductor layer 112 and sensor 116 form a first group, heating element 118 and conductor layer 114 form a second group, and the two groups are stacked and offset with respect to each other. The conductor layer and sensor in the first group and the heating element and conductor layer in the second group are connected by vias 130. Conductor layer 112 and sensor 116 are connected by vias 130 and heating element 118 and conductor layer 114 are also connected by vias 130. FIG. 6 shows two via connections within each group, but more or fewer via connections may be present depending on whether the conductor layers and sensors or heating elements are connected in series or parallel and the number of conductor, sensor or heating element segments present in a conductor, sensor or heating element layer.

The multi-layer heating assemblies 10, 30, 50, 80, and 110 illustrated in FIGS. 2 through 6 have a thickness depending on the number of layers in the assembly and the thicknesses of the layers. Gas turbine components are often composite components having several plies of fabric materials. Generally, the heating assemblies occupy a single ply or part of a single ply of a component's structure. Heating assemblies with four conductive layers and five non-conductive layers, such as those illustrated in FIGS. 3 through 6, may occupy a single ply. If additional conductive and non-conductive layers are added to the multi-layer heating assembly, the multi-layer heating assembly may occupy two or more plies of the component. Heating assemblies may or may not span the entire length or width of a component ply. In an embodiment where the multi-layer heating assembly is located on only a portion of the component ply, a layer of fabric material may be positioned near or around the multi-layer heating assembly to “fill in” the component ply layer and/or provide structure necessary for the strength and integrity of the component.

Multi-layer heating assemblies 10, 30, 50, 80, and 110 provide for a method of preventing ice accumulation on a component. Multi-layer heating assemblies 10, 30, 50, 80, and 110 are embedded in a component or mounted to a component surface. Electrical energy is provided to one or more heating elements of multi-layer heating assemblies 10, 30, 50, 80, and 110 to heat the component. The method provides for failure immunity. When one heating element fails, electrical energy is delivered to a second heating element to heat the component. The method also provides for variable watt density. When a higher watt density is needed, electrical energy is provided to additional heating elements. When a lower watt density is needed electrical energy is provided to fewer than all heating elements.

In summary, the present invention relates to a multi-layer heating assembly and a method of preventing ice accumulation on a component having a multi-layer heating assembly. Multi-layer heating assemblies may be used for failure immunity and to provide variable watt density.

Although the present invention has been described with reference to exemplary embodiments, workers skilled in the art will recognize that changes may be made in form and detail without departing from the spirit and scope of the invention.

1. An apparatus for ice protection comprising:
a first heating element;
a second heating element; and
a dielectric support having a first surface and a second surface opposite the first surface, wherein the first heating element is located on the first surface and the second heating element is located on the second surface.

2. The apparatus of claim 1, wherein the first heating element and the second heating element are connected in series.

3. The apparatus of claim 2, wherein the first heating element and the second heating element are electrically connected by vias.

4. The apparatus of claim 1, wherein the first heating element and the second heating element are connected in parallel.

5. The apparatus of claim 1, wherein the first heating element and the second heating element are configured to operate independently.

6. The apparatus of claim 1, wherein the first heating element defines a first heating path trace and the second heating element defines a second heating path trace and the first and second heating path traces are arranged in a stacked and offset relationship.

7. The apparatus of claim 1, wherein the dielectric support is a non-conductive polymer.

8. The apparatus of claim 7, wherein the dielectric support is selected from the group consisting of polyimides, fabric polymer matrices, polymer films and combinations thereof.

9. The apparatus of claim 1, wherein the first and second heating elements have a thickness between about 0.001 inches (0.0254 mm) and about 0.003 inches (0.0762 mm).

10. The apparatus of claim 1, wherein the dielectric support has a thickness between about 0.001 inches (0.0254 mm) and about 0.003 inches (0.0762 mm).

11. The apparatus of claim 1 further comprising a non-conductive cover layer, wherein the non-conductive cover layer is located on the first heating element opposite the dielectric support.

12. The apparatus of claim 1, wherein the first heating element and the second heating element have generally equivalent watt densities.

13. The apparatus of claim 1, wherein the first and second heating elements provide ice protection for a gas turbine component.

14. An apparatus comprising:
a first conductive layer;
a second conductive layer;
a third conductive layer;
a fourth conductive layer; and
a plurality of dielectric supports spaced between the first and second conductive layers, the second and third conductive layers, and the third and fourth conductive layers,
wherein at least one of the conductive layers is configured to provide ice protection.

15. The apparatus of claim 14, wherein the first, second, third, and fourth conductive layers comprise heating elements.

16. The apparatus of claim 14, wherein the first and second conductive layers are electrically connected by vias and the third and fourth conductive layers are electrically connected by vias.

17. The apparatus of claim 16, wherein the second and third conductive layers comprise heating elements.

18. The apparatus of claim 16, wherein the second conductive layer comprises a sensor and the third conductive layer comprises a heating element.

19. The apparatus of claim 14 further comprising a non-conductive cover layer, wherein the non-conductive cover layer is located on the first conductive layer.

20. The apparatus of claim 14, wherein the first conductive layer defines a first conductive path trace and the third conductive layer defines a third conductive path trace and the first and third conductive path traces overlap, and wherein the second conductive layer defines a second conductive path trace and the fourth conductive layer defines a fourth conductive path trace and the second and fourth conductive path traces overlap, and wherein the first and third conductive path traces are offset with respect to the second and fourth conductive path traces.

21. The apparatus of claim 14, wherein the first conductive path trace and the second conductive path trace overlap, and wherein the third conductive path trace and the fourth conductive path trace overlap, and wherein the first and second conductive path traces are offset with respect to the third and fourth conductive path traces.

22. A method of preventing ice accumulation on a component, the method comprising:
mounting a multi-layer heating assembly to the component, wherein the multi-layer heating assembly comprises first and second heating elements configured to provide ice protection, and a dielectric support having a first surface and a second surface opposite the first surface, wherein the first heating element is located on the first surface and the second heating element is located on the second surface; and
providing electrical energy to at least one of the first and second heating elements to heat the component.

23. The method of claim 22, wherein electrical energy is provided to the second heating element after the first heating element fails.

24. The method of claim 22, wherein electrical energy is provided to the first and second heating elements simultaneously to increase a watt density of the multi-layer heating assembly.
